(19) United States
(12) Patent Application Publication
(10) Pub. No.: US 2005/0165351 A1
(43) Pub. Date: Jul. 28, 2005

(54) No choke cover cap

(76) Inventor: Henry A. Tamagni JR., Vineland, NJ (US)

Correspondence Address: James G. O'Boyle, Esq., 711 Chevy Chase Building, 5530 Wisconsin Avenue, Chevy Chase, MD, 20815, US

(21) Appl. No.: 11/043,149

(22) Filed: Jan. 27, 2005

Related U.S. Application Data
(60) Provisional application No. 60/540,085, filed on Jan. 28, 2004.

(51) Int. Cl. A61J 7/00

(52) U.S. Cl. 604/77; 604/187

(57) ABSTRACT

A no choke cover cap for mounting on the discharge tip of a dosage syringe for sealing a predetermined dosage of a liquid medication in the syringe. The cover cap is provided with a base portion dimensioned to not only prevent the cap from being swallowed by a child but also to function as a stand to support the prefilled syringe in a vertical position for storage. The base portion is provided with apertures to form air passages to prevent a child from choking if the cap is placed in the child's mouth.

### CROSS-REFERENCE TO RELATED APPLICATION

This application claims the benefit of Provisional Patent Application Ser. No. 60/540,085 filed Jan. 28, 2004.

### BACKGROUND OF THE INVENTION

Various types of dispensers; such as cups, spoons, droppers and syringes are commonly used for administrating liquid oral medications.

Infants and children, who are common recipients of liquid oral medications, are the primary patient group in which the syringe-type dispensing device is used because it is generally more difficult to administer liquid medications orally to them via a cup or spoon.

The syringe type dispenser consists of a barrel having a plunger slidably mounted in one end thereof and a discharge opening in the opposite end of the barrel. In use, it is common for the person administering the medication to fill the syringe by drawing a predetermined dose into the barrel and placing a small cap on the discharge opening of the barrel when the medication is to be administered at a later time. Having a prefilled syringe with a small cap on the end in the presence of infants can present a choking hazard, in some cases, either through direct removal and subsequent swallowing of the cap by the infant or inadvertently dispensing the cap along with the medication directly into the infant's mouth by the person administering the medication.

To overcome the chance of an infant or small child choking or swallowing a small cap placed on a prefilled syringe type liquid medication dispenser, the cap of the present invention has been devised.

### SUMMARY OF THE INVENTION

The no choke cover cap of the present invention comprises, essentially, a base portion having a sleeve integral therewith and extending axially therefrom. The sleeve includes a configured bore and a centrally mounted nipple adapted to be mounted on the discharge end of the syringe barrel to thereby provide a closure for the syringe. The cover base is dimensioned to a size to not only prevent its insertion into an infant's mouth, but also to function as a supporting stand for the syringe. A plurality of apertures are provided in the base to provide air passageways if a child happens to get the cap stuck in its mouth.

### DESCRIPTION OF THE DRAWINGS

FIG. 1 is a perspective view of the no choke cover cap in accordance with the present invention;

FIG. 2 is a top plan view thereof;

FIG. 3 is a view taken along line 3-3 of FIG. 2.

FIG. 4 is a sectional side elevational view of the cap mounted on the discharge end of a dosage syringe; and

FIG. 5 is a perspective view illustrating the size of the cap relative to a child's mouth.

### DESCRIPTION OF THE PREFERRED EMBODIMENT

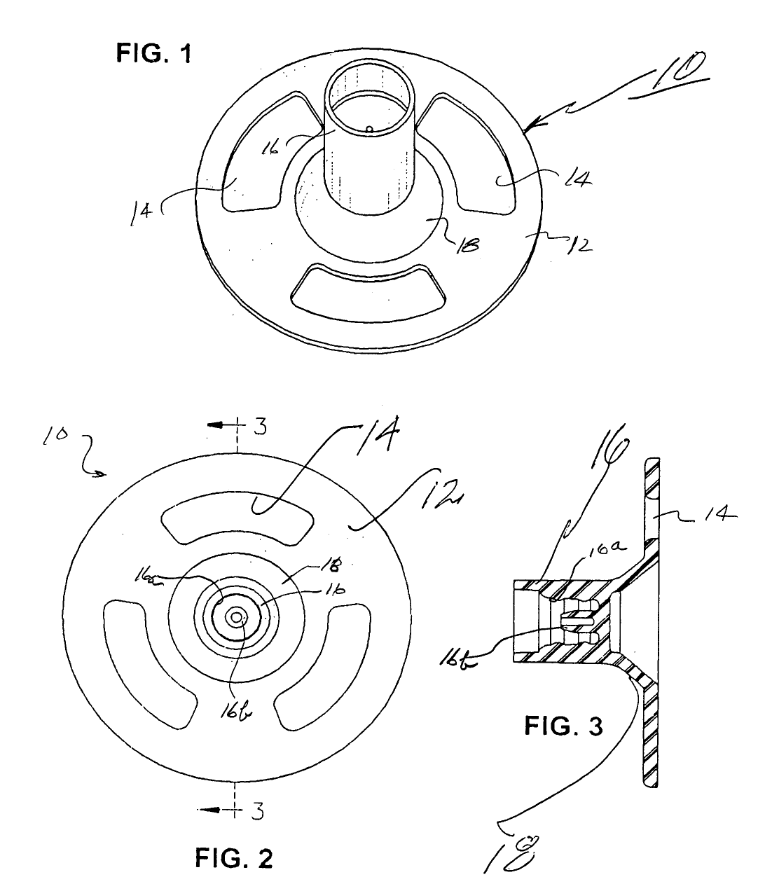

Referring to the drawings and more particularly to FIGS. 1 to 3, the no choke cover cap 10 of the present invention comprises an annular base 12 having apertures 14 and a sleeve 16 integral therewith by a frusto-conical wall 18 and extending axially therefrom. The sleeve 16 includes a configured bore 16a and a centrally mounted, axially extending nipple 16b.

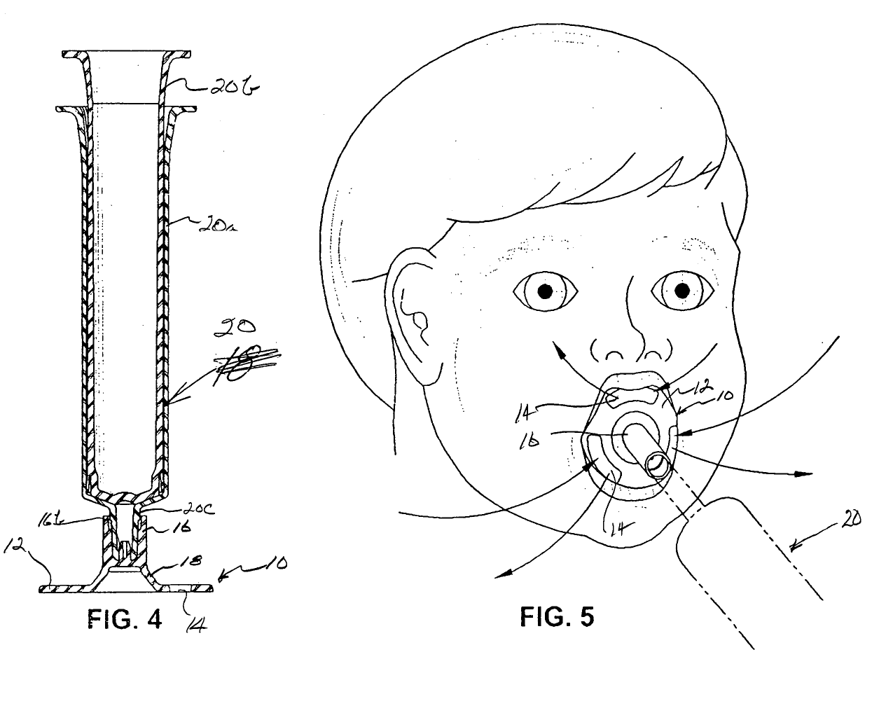

As will be seen in FIG. 4, the no choke cover cap 10 of the present invention is to be used with a conventional dosage syringe 20 having a barrel 20a and a plunger 20b slidably mounted in one end thereof. A discharge tip 20c is provided on the opposite end of the barrel onto which the cap 10 is adapted to be mounted by inserting the tip 20c into the sleeve portion 16 of the cap so that the nipple 16b is inserted into the open end of the tip. The cap 10 is frictionally held on the syringe tip 20c to thereby seal the dosage contained in the syringe barrel.

In use, the syringe is filled with a predetermined dose of liquid medication, and the cap 10 is placed on the syringe tip 20c to seal the medication therein so that it may be dispensed at a later time. To dispense the medication, the cap 10 is removed from the tip of the syringe 20 so that the tip 20c can be placed into the mouth of a child whereby the medication is dispensed from the syringe.

As opposed to dosage syringes having small closure caps, the base 12 of the cover cap of the present invention is dimensioned to have a diameter of such a size that the cap cannot be fully inserted into a child's mouth as shown in FIG. 5 if the person administering the medication should forget to remove the cap from the syringe when administering the medication. If the cap 10 should happen to enter the child's mouth, the apertures 14 provide air passageways to prevent the child from choking.

The size of the base 12 is such that it can also function as a stand for the syringe, as shown in FIG. 4, rendering it easier and more convenient to store and use.

It is to be understood that the form of the invention herewith shown and described is to be taken as a preferred example of the same, and that various changes in the shape, size, and arrangement of parts may be resorted to, without departing from, the spirit of the invention or scope of the subjoined claims.

1. A no choke cover cap for a dosage syringe of the type having a plunger slidably mounted in one end of a barrel having an open ended discharge tip on the other end thereof, comprising a base portion, a sleeve integral with the base portion and extending axially therefrom, a nipple mounted coaxially within said sleeve, whereby a predetermined dosage is sealed within the barrel by inserting the discharge tip into the sleeve and the nipple into the open end of the tip, the base portion of the cover being dimensioned to prevent the cap from being swallowed by a child.

2. A no choke cover cap, according to claim 1, wherein apertures are provided in the base portion to thereby form air passages to prevent a child from choking if the cover is placed in the child's mouth.

3. A no choke cover cap, according to claim 1, wherein the base portion is annular having a predetermined diameter to prevent the cover from being swallowed by a child.

4. A no choke cover cap, according to claim 3 wherein the base portion functions as a stand to support the sealed syringe in a vertical position.
